(19) United States
(12) Patent Application Publication
(10) Pub. No.: US 2021/0390723 A1
(43) Pub. Date: Dec. 16, 2021

(54) MONOCULAR UNSUPERVISED DEPTH ESTIMATION METHOD BASED ON CONTEXTUAL ATTENTION MECHANISM

(71) Applicant: DALIAN UNIVERSITY OF TECHNOLOGY, Dalian (CN)

(72) Inventors: Xinchen YE, Dalian (CN); Rui XU, Dalian (CN); Xin FAN, Dalian (CN)

(21) Appl. No.: 17/109,838

(22) Filed: Dec. 2, 2020

(30) Foreign Application Priority Data
Jun. 15, 2020 (CN) 202010541514.3

(51) Int. Cl. G06T 7/564; G06T 9/00; G06T 7/73; G06K 9/62; G06N 3/08; G06N 3/04

(52) U.S. Cl. CPC G06T 7/564; G06T 9/002; G06T 7/75; G06K 9/6265; G06T 2207/20084; G06N 3/08; G06N 3/04; G06T 2207/10016; G06T 2207/20081; G06K 9/6234

(57) ABSTRACT

The present invention provides a monocular unsupervised depth estimation method based on contextual attention mechanism, belonging to the technical field of image processing and computer vision. The invention adopts a depth estimation method based on a hybrid geometric enhancement loss function and a context attention mechanism, and adopts a depth estimation sub-network, an edge sub-network and a camera pose estimation sub-network based on convolutional neural network to obtain high-quality depth maps. The present invention uses convolutional neural network to obtain the corresponding high-quality depth map from the monocular image sequences in an end-to-end manner. The system is easy to construct, the program framework is easy to implement, and the algorithm runs fast; the method uses an unsupervised method to solve the depth information, avoiding the problem that ground-truth data is difficult to obtain in the supervised method.

### TECHNICAL FIELD

The present invention belongs to the technical field of computer vision and image processing, and involves to use depth estimation sub-network, edge sub-network and camera pose estimation sub-network based on convolutional neural network to jointly obtain the high-quality depth maps. Specifically, it relates to a monocular unsupervised depth estimation method based on a contextual attention mechanism.

### BACKGROUND

At this stage, as a basic research task in the field of computer vision, depth estimation has a wide range of applications in the fields of target detection, automatic driving, simultaneous localization and map construction and so on. For depth estimation, especially monocular depth estimation, without geometric constraints and other prior knowledge, predicting a depth map from a single image is an extremely ill-posed problem. So far, the monocular depth estimation methods based on deep learning are mainly divided into two categories: supervised methods and unsupervised methods. Although the supervised methods can obtain better depth estimation results, they require a large amount of ground-truth depth data as supervision information, and these ground-truth depth data are not easy to obtain. In contrast, unsupervised methods propose to transform the depth estimation problem into a viewpoint synthesis problem, thereby avoiding the use of ground-truth depth data as supervised information during the training process. According to different training data, unsupervised methods can be further subdivided into depth estimation methods based on stereo matching pairs and monocular videos. Among them, the unsupervised method based on stereo matching pairs guides the parameters' update of the entire network by establishing photometric loss between the left and right images during the training process. However, the stereo image pairs used for training are usually difficult to obtain and need to be corrected in advance, which limits the practical application of such methods. The unsupervised methods based on monocular video propose to use monocular image sequences, namely monocular video, in the training process, and predict the depth map by establishing the photometric loss between two adjacent frames (T. Zhou, M. Brown, N. Snavely, D. G. Lowe, Unsupervised learning of depth and ego-motion from video, in: IEEE CVPR, 2017, pp. 1-7). Since the camera pose between adjacent frames of the video is unknown, it is necessary to estimate the depth and camera pose at the same time during training Although the current unsupervised loss function is simple in form, its disadvantage is that it cannot guarantee the sharpness of the depth edge and the integrity of the fine structure of the depth map, especially in the occlusion and low-texture areas, which will produce low-quality depth estimation maps. In addition, the current monocular depth estimation methods based on deep learning usually cannot obtain the correlation between long-range features, and thus cannot obtain a better feature expression, resulting in problems such as loss of details in the estimated depth map.

### SUMMARY

To solve the above-mentioned problem, the present invention provides a monocular unsupervised depth estimation method based on context attention mechanism, and designs a framework for high-quality depth prediction based on convolutional neural networks. The framework includes four parts: depth estimation sub-network, edge estimator sub-network, camera pose estimation sub-network and discriminator. It proposes a context attention mechanism module to effectively acquire features, and construct a hybrid geometric enhancement loss function to train the entire framework to obtain high-quality depth information.

The specific technical solution of the present invention is a monocular unsupervised depth estimation method based on context attention mechanism, which contains the following steps:

(1) preparing initial data, the initial data includes the monocular video sequence used for training and the single image or sequence used for testing;

(2) the construction of depth estimation sub-network and edge estimation sub-network and the construction of context attention mechanism:

(2-1) using the encoder-decoder structure, the residual network containing the residual structure is used as the main structure of the encoder to convert the input color map into the feature map; the depth estimation sub-network and the edge estimation sub-network share the encoder, but have their own decoders, which are easy to output their respective features; the decoders contain deconvolution layers for up-sampling the feature map and converting the feature map into a depth map or edge map;

(2-2) constructing the context attention mechanism into the decoder of the depth estimation sub-network;

(3) the construction of the camera pose sub-network:

the camera pose sub-network contains an average pooling layer and more than five convolutional layers, and except for the last convolutional layer, all other convolutional layers adopt batch normalization and ReLU activation function;

(4) the construction of the discriminator structure: the discriminator structure contains more than five convolutional layers, each of which uses batch normalization and Leaky-ReLU activation functions, and the final fully connected layer;

(5) the construction of a loss function based on hybrid geometry enhancement;

(6) training the whole network composed by (2), (3) and (4); the supervision method adopts the loss function based on the hybrid geometric enhancement constructed in step 5) to gradually optimize the network parameters; after training, using the trained model to test on the test set to get the output result of the corresponding input image.

Furthermore, the construction of the context attention mechanism in step 2-2) above specifically includes the following steps:

the context attention mechanism is added to the front end of the decoder of the depth estimation network; the feature map obtained by the previous encoder network is A∈ [symbol] ^{H×W×C}, where H, W, C respectively represent the height, width, and number of channels; at first, transform A into B∈ [symbol] ^{N×C}(N=H×W), and then multiply B and its transposed matrix B^{T}; the result can get the spatial attention map S∈ [symbol] ^{N×N} or channel attention map S∈ [symbol] ^{C×C} after the softmax activation function operation, that is, S=softmax(BB^{T}) or S=softmax(B^{T}B); next, perform matrix multiplication on S and B and transform them into U∈ [symbol] ^{H×W×C} and finally add the original feature map A and U pixel by pixel to get the final feature output Aₐ.

The present invention has the following beneficial effects:

The present invention is designed based on CNN. It builds a depth estimation sub-network and an edge sub-network based on a 50-layer residual network to obtain a preliminary depth map and an edge information map. At the same time, the camera pose estimation sub-network is used to obtain the camera pose information. This information and the preliminary depth map are used to obtain synthetic adjacent frame color maps through the warping function, and then the synthetic image is optimized by the hybrid geometric enhancement loss function; finally, the optimized synthetic image is distinguished from the real color map by the discriminator, the discriminator optimizes the difference through the adversarial loss function. When the difference is small enough, a high-quality estimated depth map can be obtained. The present invention has the following characteristics:

1. it is easy to construct the system. This system can obtain the high-quality depth map from the monocular video directly by the well-trained end to end convolutional neural network. The program framework is easy to implement and the algorithm runs fast.

2. the present invention uses an unsupervised method to analyze the depth information, avoiding the problem that ground-truth data is difficult to obtain in the supervised method.

3. the present invention uses monocular picture sequences to solve the depth information, avoiding the problem of difficulty in obtaining stereo picture pairs when solving the depth information.

4. the context attention mechanism and hybrid geometric loss function designed in the present invention can effectively improve performance.

5. the invention has good scalability, and can realize more accurate depth estimation by combining different monocular cameras to realize algorithms.

### DESCRIPTION OF DRAWINGS

FIG. 1 is the structure diagram of convolutional neural network proposed by the present invention.

FIG. 2 is the structure diagram of attention mechanism.

FIG. 3 is the results show. (a) Input color image; (b) Ground truth depth map; (c) Results of the present invention.

### DETAILED DESCRIPTION

The present invention proposes a monocular unsupervised depth estimation method based on a context attention mechanism, which is described in detail with reference to the drawings and embodiments as follows:

The method includes the following steps:

(1) preparing initial data:

(1-1) use two public datasets, KITTI dataset and Make3D dataset to evaluate the invention;

(1-2) the KITTI dataset is used for training and testing of the present invention. It has a total of 40,000 training samples, 4,000 verification samples, and 697 test samples. During training, the original image resolution size of 375×1242 is scaled to 128×416. The length of the input image sequence during training is set to 3, and the middle frame is the target view while the other frames are the source views.

(1-3) the Make3D dataset is mainly used to test the generalization performance of the present invention on different datasets. The Make3D dataset has a total of 400 training samples and 134 test samples. Here, the present invention only selects the test set of the Make3D dataset, and the training model comes from the KITTI dataset. The resolution of the original image in the Make3D dataset is 2272×1704. By cropping the central area, the image resolution is changed to 525×1704 so that the sample set has the same aspect ratio as the KITTI sample, and then its size is scaled to 128×416 as input for network testing.

(1-4) the input during the test can be either a sequence of images with the length of 3 or a single image.

(2) the construction of depth estimation sub-network and edge sub-network and the construction of context attention mechanism:

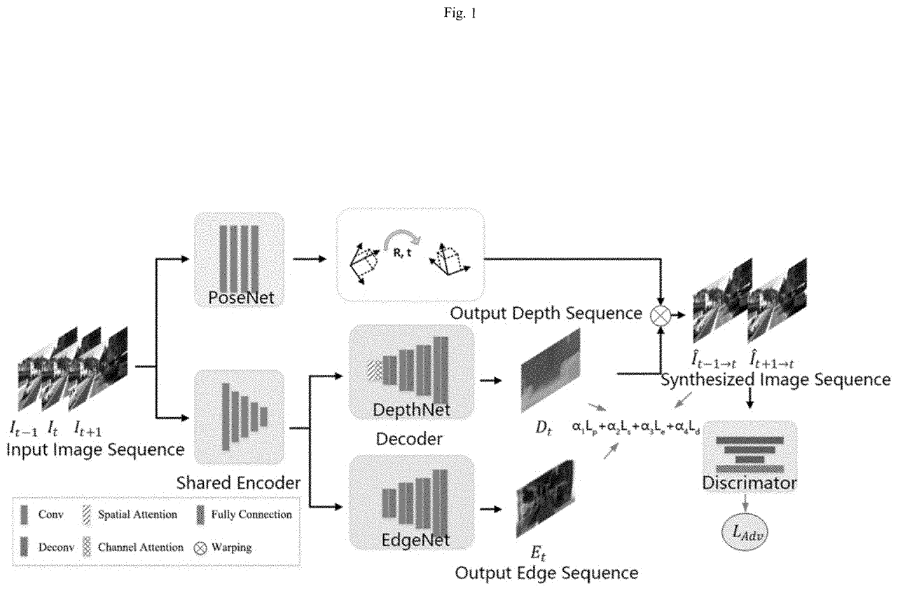

(2-1) as shown in FIG. 1, the main architecture of the depth estimation and edge estimation network is mainly based on the encoder-decoder structure (N. Mayer, E. Ilg, P. Hausser, P. Fischer, D. Cremers, A. Dosovitskiy, T. Brox, A large dataset to train convolutional networks for disparity, optical flow, and scene flow estimation, in: IEEE CVPR, 2016, pp. 4040-4048). Specifically, the encoder part adopts a residual network containing a 50-layer residual structure (ResNet50), which converts the input color map into feature maps and obtains multi-scale features by using a convolutional layer with a step size of 2 to downsample the feature map layer by layer. In order to reduce the training parameters, the depth estimation network and the edge network adopt a shared encoder design, and the decoder part is unique to output its own characteristics. The network structure of the decoder part is symmetrical to the network structure of the encoder part. It mainly contains deconvolution layers, which infer the final depth map or edge map by gradually up-sampling the feature map. In order to enhance the feature expression ability of the network, the encoder-decoder structure uses skip connections to connect the feature maps with the same spatial dimensions of the encoder and decoder parts.

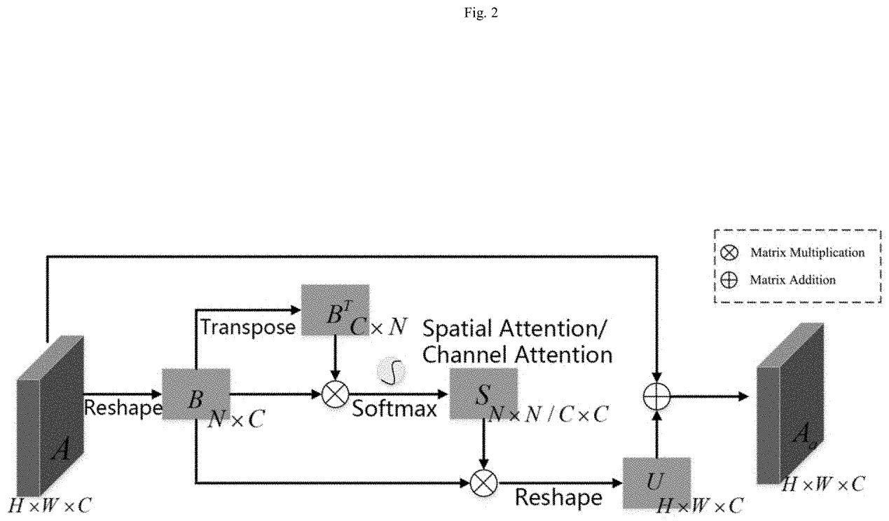

The context attention mechanism is added to the front end of the decoder of the depth estimation network; the context attention mechanism is shown in FIG. 2. The feature map obtained by the previous encoder network is A∈ [symbol] ^{H×W×C}, where H, W, C respectively represent the height, width, and number of channels. At first, transform A into B∈ [symbol] ^{N×C}(N=H×W), and then multiply B and its transposed matrix B^{T}. The result can get the spatial attention map S∈ [symbol] ^{N×N} or channel attention map S∈ [symbol] ^{C×C} after the Softmax activation function operation, that is, S=softmax(BB^{T}) or S=softmax(B^{T}B). Next, we perform matrix multiplication on S and B and transform them into U∈ [symbol] ^{H×W×C} and finally add the original feature map A and U pixel by pixel to get the final feature output Aₐ. Experiments have proved that the effect of this attention mechanism added to the forefront of the depth estimation sub-network decoder is significantly improved. On this basis, adding this mechanism to other networks is difficult to improve the effect and will significantly increase the amount of network parameters.

(3) construction of camera pose network:

the camera pose network is mainly used to estimate the pose transformation between two adjacent frames, where the pose transformation refers to the displacement and rotation of the corresponding position between the two adjacent frames. The camera pose network consists of an average pooling layer and eight convolutional layers. Except for the last convolutional layer, all other convolutional layers use batch normalization (BN) and ReLU (Rectified Linear Unit) activation functions.

(4) construction of the discriminator structure:

the discriminator is mainly used to judge the authenticity of the color map, that is, to determine whether it is a real color map or a synthesized color map. Its purpose is to enhance the ability of the network to synthesize color maps to thereby indirectly improving the quality of depth estimation. The discriminator structure contains five convolutional layers, each of which uses batch normalization and Leaky-ReLU activation functions, and the final fully connected layer.

(5) in order to solve the problem that the ordinary unsupervised loss function is difficult to produce high-quality results in the edge, occlusion and low-texture areas, this invention constructs the loss function based on hybrid geometric enhancement to train the network.

(5-1) designing the photometric loss function Lₚ; use the depth map information and the camera pose to obtain the source frame image coordinates from the target frame image coordinates, and establish the projection relationship between adjacent frames; the formula is:

pₛ=KT_{t→s}Dₜ(pₜ)K⁻¹pₜ

where K is the camera calibration parameter matrix, K⁻¹ is the inverse matrix of the parameter matrix, Dₜ is the predicted depth map, s and t represent the source frame and the target frame, respectively; T_{t→s} is the camera pose information from t to s, pₛ is the image coordinate of the source frame, and pₜ is the image coordinate of the target frame; the source frame image Iₛ is warped to the target frame angle of view to obtain the synthesized image Î_{s→t}, which is expressed as follows:

$${\hat{I}}_{s \to t} ( {p}_{t} ) = {I}_{s} ( {p}_{s} ) = {\sum }_{j ∈ \{ t , b , l , r \}} {w}^{j} {I}_{s} ( {p}_{s}^{j} )$$

among them, w^{j} is the linear interpolation coefficient, and the value is ¼; pₛ^{j} is the adjacent pixel in pₛ, j∈{t,b,l,r} represents 4-neighborhood, and t, b, l, r represent the top, bottom, left and right ends of the coordinate position;

Lₚ is defined as follows:

$${L}_{p} = \frac{1}{N} {\sum }_{t = 1}^{N} {\sum }_{{p}_{t}} {M}_{t}^{*} ( {p}_{t} ) \vert {I}_{t} ( {p}_{t} ) - {\hat{I}}_{s \to t} ( {p}_{t} ) \vert$$

among them, N represents the number of images per training, the effective mask Mₜ*=1−M, M is defined as: M=I(ξ≥0), where I is the indicator function, and the definition of ξ is ξ=∥Dₜ−Ďₜ∥²−(n₁∥Dₜ∥²+η₁∥Ďₜ∥²+η₂), where η₁ and η₂ are weight coefficients set to 0.01 and 0.5 respectively; Ďₜ is a depth map generated by warping the depth map Dₜ of the target frame;

(5-2) designing space smooth loss function L_{S}, used to process the depth value of low-texture areas, the formula is as follows:

$${L}_{s} = \frac{1}{N} {\sum }_{t = 1}^{N} {\sum }_{{p}_{t}} ( ‖ {∇}_{x}^{2} {D}_{t} ( {p}_{t} ) ‖ {e}^{- γ \vert {E}_{t} ( {p}_{t} ) \vert} + ‖ {∇}_{y}^{2} {D}_{t} ( {p}_{t} ) ‖ {e}^{- γ \vert {E}_{t} ( {p}_{t} ) \vert} )$$

among them, the parameter γ is set to 10, Eₜ is the output result of the edge sub-network, and ∇ₓ² and ∇_{y}² are the two-step gradient in the x and y directions of the coordinate system, respectively; to avoid getting trivial solutions, design the edge regularization loss function Lₑ, the formula is as follows:

$${L}_{e} = \frac{1}{N} {\sum }_{t = 1}^{N} {\sum }_{{p}_{t}} {\vert {E}_{t} ( {p}_{t} ) \vert}^{2}$$

(5-3) designing the left and right consistency loss function L_{d} to eliminate the error caused by occlusion between the viewpoints; the formula is as follows:

$${L}_{d} = \frac{1}{N} {\sum }_{t = 1}^{N} {\sum }_{{p}_{t}} \vert {D}_{t} ( {p}_{t} ) - {\breve{D}}_{t} ( {p}_{t} ) \vert$$

(5-4) the discriminator uses the adversarial loss function when distinguishing real images and synthetic images; regarding the combination of deep network, edge network, and camera pose network as the generator, and the final synthesized image is sent to the judgment together with the real input image to get better results in the device; the adversarial loss function formula is as follows:

$${L}_{Adv} = \frac{1}{N} {\sum }_{t = 1}^{N} \{ {𝔼}_{{I}_{t} ∼ P ( {I}_{t} )} [ log 𝔻 ( {I}_{t} ) ] + {𝔼}_{{\hat{I}}_{s \to t} ∼ P ( {\hat{I}}_{s \to t} )} [ log ( 1 - 𝔻 ( {\hat{I}}_{s \to t} ) ) ] \}$$

among them, P(*) represents the probability distribution of the data *, E represents the expectation, and D represents the discriminator; this adversarial loss function prompts the generator to learn the mapping of synthetic data to real data, so that the synthetic image is similar to the real image;

(5-5) the loss function of the overall network structure is defined as follows:

L=α₁Lₚ+α₂Lₛ+α₃Lₑ+α₄L_{d}+α₅L_{Adv}

among them, α₁, α₂, α₃, α₄ and α₅ are the weight coefficients.

(6) the convolutional neural networks obtained from (2), (3) and (4) into the network structure are combined as shown in FIG. 1 and then the joint training is performed. The data enhancement strategy proposed in the paper (A. Krizhevsky, I. Sutskever, G. E. Hinton, Imagenet classification with deep convolutional neural networks, in: NIPS, 2012, pp. 1097-1105) is used to enhance the initial data and reduce over-fitting problem. The supervision method adopts the hybrid geometric enhancement loss function constructed in (5) to gradually iteratively optimize the network parameters. During the training process, the batch size is set to 4, and the Adam optimization method with β₁=0.9 and β₂=0.999 is used for optimization, and the initial learning rate is set to 1e−4. When the training is completed, the trained model can be used to test on the test set to obtain the output result of the corresponding input image.

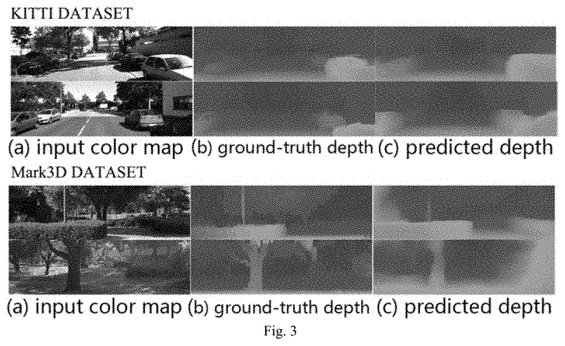

The final result of this implementation is shown in FIG. 3, where (a) is the input color map, (b) is the ground-truth depth map and (c) is the output depth map result of the present invention.

1. An unsupervised method for monocular depth estimation based on contextual attention mechanism, wherein comprising the following steps:
(1) preparing initial data, the initial data includes the monocular video sequence used for training and the single image or sequence used for testing;
(2) the construction of depth estimation sub-network and edge estimation sub-network and the construction of context attention mechanism:
(2-1) using the encoder-decoder structure, the residual network containing the residual structure is used as the main structure of the encoder to convert the input color map into the feature map; the depth estimation sub-network and the edge estimation sub-network share the encoder, but have their own decoders, which are easy to output their respective features; the decoders contain deconvolution layers for up-sampling the feature map and converting the feature map into a depth map or edge map;
(2-2) constructing the context attention mechanism into the decoder of the depth estimation sub-network;
(3) the construction of the camera pose sub-network:
the camera pose sub-network contains an average pooling layer and more than five convolutional layers, and except for the last convolutional layer, all other convolutional layers adopt batch normalization and ReLU activation function;
(4) the construction of the discriminator structure: the discriminator structure contains more than five convolutional layers, each of which uses batch normalization and Leaky-ReLU activation functions, and the final fully connected layer;
(5) the construction of a loss function based on hybrid geometry enhancement;
(6) training the whole network composed by (2), (3) and (4); the supervision method adopts the loss function based on the hybrid geometric enhancement constructed in step 5) to gradually optimize the network parameters; after training, using the trained model to test on the test set to get the output result of the corresponding input image.

2. The unsupervised method for monocular depth estimation based on contextual attention mechanism according to claim 1, wherein the construction of the context attention mechanism in step (2-2) specifically includes the following steps:
the context attention mechanism is added to the front end of the decoder of the depth estimation network; the feature map obtained by the previous encoder network is A∈ [symbol] ^{H×W×C}, where H, W, C respectively represent the height, width, and number of channels; at first, transform A into B∈ [symbol] ^{N×C}(N=H×W), and then multiply B and its transposed matrix B^{T}; the result can get the spatial attention map S∈ [symbol] ^{N×N} or channel attention map S∈ [symbol] ^{C×C} after the softmax activation function operation, that is, S=softmax(BB^{T}) or S=softmax(B^{T}B); next, perform matrix multiplication on S and B and transform them into U∈ [symbol] ^{H×W×C} and finally add the original feature map A and U pixel by pixel to get the final feature output Aₐ.

3. The unsupervised method for monocular depth estimation based on contextual attention mechanism according to claim 1, wherein the construction of a loss function based on hybrid geometric enhancement specifically includes the following steps:
(5-1) designing the photometric loss function Lₚ; use the depth map information and the camera pose to obtain the source frame image coordinates from the target frame image coordinates, and establish the projection relationship between adjacent frames; the formula is:
pₛ=KT_{t→s}Dₜ(pₜ)K⁻¹pₜ
where K is the camera calibration parameter matrix, K⁻¹ is the inverse matrix of the parameter matrix, Dₜ is the predicted depth map, s and t represent the source frame and the target frame, respectively; T_{t→s} is the camera pose information from t to s, pₛ is the image coordinate of the source frame, and pₜ is the image coordinate of the target frame; the source frame image Iₛ is warped to the target frame angle of view to obtain the synthesized image Î_{s→t}, which is expressed as follows:
$${\hat{I}}_{s \to t} ( {p}_{t} ) = {I}_{s} ( {p}_{s} ) = {\sum }_{j ∈ \{ t , b , l , r \}} {w}^{j} {I}_{s} ( {p}_{s}^{j} )$$
among them, w^{j} is the linear interpolation coefficient, and the value is ¼; pₛ^{j} is the adjacent pixel in pₛ, j∈{t,b,l,r} represents 4-neighborhood, and t, b, l, r represent the top, bottom, left and right ends of the coordinate position;
Lₚ is defined as follows:
$${L}_{p} = \frac{1}{N} {\sum }_{t = 1}^{N} {\sum }_{{p}_{t}} {M}_{t}^{*} ( {p}_{t} ) \vert {I}_{t} ( {p}_{t} ) - {\hat{I}}_{s \to t} ( {p}_{t} ) \vert$$
among them, N represents the number of images per training, the effective mask Mₜ*=1−M, M is defined as: M=I(ξ≥0), where I is the indicator function, and the definition of ξ is ξ=∥Dₜ−\hat{D}ₜ∥²−(η₁∥Ďₜ∥²+η₂), where η₁ and η₂ are weight coefficients set to 0.01 and 0.5 respectively; Ďₜ is a depth map generated by warping the depth map Dₜ of the target frame;
(5-2) designing space smooth loss function Lₛ, used to process the depth value of low-texture areas, the formula is as follows:
$${L}_{s} = \frac{1}{N} {\sum }_{t = 1}^{N} {\sum }_{{p}_{t}} ( ‖ {∇}_{x}^{2} {D}_{t} ( {p}_{t} ) ‖ {e}^{- γ \vert {E}_{t} ( {p}_{t} ) \vert} + ‖ {∇}_{y}^{2} {D}_{t} ( {p}_{t} ) ‖ {e}^{- γ \vert {E}_{t} ( {p}_{t} ) \vert} )$$
among them, the parameter γ is set to 10, Eₜ is the output result of the edge sub-network, and ∇ₓ² and ∇_{y}² are the two-step gradient in the x and y directions of the coordinate system, respectively; to avoid getting trivial solutions, design the edge regularization loss function Lₑ, the formula is as follows:
$${L}_{e} = \frac{1}{N} {\sum }_{t = 1}^{N} {\sum }_{{p}_{t}} {\vert {E}_{t} ( {p}_{t} ) \vert}^{2}$$
(5-3) designing the left and right consistency loss function L_{d} to eliminate the error caused by occlusion between the viewpoints; the formula is as follows:
$${L}_{d} = \frac{1}{N} {\sum }_{t = 1}^{N} {\sum }_{{p}_{t}} \vert {D}_{t} ( {p}_{t} ) - {\check{D}}_{t} ( {p}_{t} ) \vert$$
(5-4) the discriminator uses the adversarial loss function when distinguishing real images and synthetic images; regarding the combination of deep network, edge network, and camera pose network as the generator, and the final synthesized image is sent to the judgment together with the real input image to get better results in the device; the adversarial loss function formula is as follows:
$${L}_{Adv} = \frac{1}{N} {\sum }_{t = 1}^{N} \{ {E}_{{I}_{t} ∼ P ( {I}_{t} )} [ log D ( {I}_{t} ) ] + {E}_{{\hat{I}}_{s \to t} ∼ P ( {I}_{s \to t} )} [ log ( 1 - D ( {\hat{I}}_{s \to t} ) ) ] \}$$
among them, P(*) represents the probability distribution of the data *, E represents the expectation, and D represents the discriminator; this adversarial loss function prompts the generator to learn the mapping of synthetic data to real data, so that the synthetic image is similar to the real image;
(5-5) the loss function of the overall network structure is defined as follows:
L=α₁Lₚ+α₂Lₛ+α₃Lₑ+α₄L_{d}+α₅L_{Adv}
among them, α₁, α₂, α₃, α₄ and α₅ are the weight coefficients.
